(19) United States
(12) Patent Application Publication
(10) Pub. No.: US 2024/0300073 A1
(43) Pub. Date: Sep. 12, 2024

(54) Processing Machine for Flat Material Parts

(71) Applicant: Thalmann Maschinenbau AG, Frauenfeld (CH)

(72) Inventor: Stefan Kern, Kirchberg (CH)

(21) Appl. No.: 18/599,413

(22) Filed: Mar. 8, 2024

(30) Foreign Application Priority Data
Mar. 9, 2023 (EP) 23160856.3

(51) Int. Cl. B25B 11/00; B21D 5/00

(52) U.S. Cl. CPC B25B 11/005; B21D 5/002

(57) ABSTRACT

In a processing machine for feeding flat material parts thereto, the control unit controls suction cup units in a pick-up step in order to pick up two or more flat material parts corresponding to the number of suction cup units from a transfer table. The control unit then controls the individual two or more suction cup units in a multi-stage positioning step during a movement of the frame component in the feed direction into the processing machine so that these successively deposit the picked-up flat material parts on the feed table in such a way that, viewed in the feed processing direction of the feed table, no overlapping of the deposited flat material parts occurs.

### CROSS REFERENCE TO RELATED APPLICATION

This application claims priority to European Patent Application No. 23 160 856.3, filed Mar. 9, 2023, the disclosure of which is hereby incorporated by reference in its entirety.

### BACKGROUND OF THE INVENTION

### Field of the Invention

The present invention relates to a processing machine for flat material parts comprising a machine frame with a frame, a lower part and an upper part, a lower beam, an upper beam, at least one processing tool assigned to the lower beam or upper beam and held on the machine frame, a control unit for controlling a processing sequence with the processing tools, a transfer table at the side of the machine frame, a feed table on which the flat material part to be processed can be placed for positioning in the processing machine, and a side feed unit with a suction cup unit, with which the flat material part can be picked up from the transfer table and deposited on the feed table for predetermined positioning, wherein the side feed unit has a side shift rail which is firmly connected to the machine frame and on which a frame component is arranged so as to be movable in a feed direction which corresponds to the processing edge of the flat material part, wherein the suction cup unit is mounted on the frame component.

### Description of Related Art

Such a side feed unit is known from EP 3 778 048 A1. This makes it possible to keep individual sheets in stock as flat material parts on a transfer table and to transport and deposit them automatically to the correct position on the positioning table. So that long sheets can also be processed in the alignment of the processing edge, a conventional processing machine includes processing tools with a length that exceeds the maximum length of a sheet to be processed. The speed of the processing machine is limited by the transport speed of the side feed unit at which the sheets to be processed can be introduced into the processing machine.

### SUMMARY OF THE INVENTION

Based on this state of the art, the invention has as an object to increase the processing speed of the processing machine, in particular when the length of the sheets to be processed is only a fraction of the total length of the processing tools.

This object is solved in particular in that two or more suction cup units are provided, which can be controlled separately from one another by the control unit, in that these two or more suction cup units are mounted on the frame component offset transversely to the feed direction, and in that the control unit is configured to control the suction cup units for picking up two or more flat material parts from the transfer table, which number corresponds at most to the number of suction cup units, and further configured such that, when the frame component is moved in the feed direction into the processing machine, the individual two or more suction cup units are actuated such that they successively deposit the picked-up flat material parts on the feed table such that, viewed in the feed direction of the feed table, no overlapping of the deposited flat material parts occurs.

If shorter flat material parts are to be processed, in particular in processing machines with a large number of sections, it is an advantage of the processing machine of the present invention that two or more of these flat material parts can be fed to the processing machine simultaneously in one feed step, since this method improves the corresponding time-intensive feeding process. At the same time, it is possible to move the frame component back out of the processing machine after depositing the multiple flat components, while at the same time either the infeed table itself aligns the flat material parts deposited offset in its feed direction to the same side edge or this is done with slides provided between segments of the infeed table.

In order to enable secure pick-up, each suction cup unit advantageously comprises a number of suction cups arranged in a row one behind the other in the feed direction. The number of suction cups per suction cup unit can vary between 1 and a number of up to 10. Three to five suction cups per suction cup unit are useful; in the embodiment examples, “3+1” are shown in each case.

The frontmost suction cup in the feed direction can be arranged at a greater distance from the transfer table, i.e. its compressed shape in the suction position can be arranged higher than that of the other suction cups, so that the frontmost section of a flat component in the feed direction is lifted higher from the transfer table in order to ensure that only one flat component is sucked in when it is lifted from a stack of flat components and that several flat components do not still adhere to each other. The deformation of the flat component in the feed direction during suction reduces the aforementioned risk of sticking, as the rear part of the flat component remains on the stack for a short time during suction while the front part is lifted off. This function can also be realized if the undersides of the suction cups are arranged at the same height, but the first suction cup has a greater stroke during suction.

As a further option, a second suction cup from the range of suction cup units can also have the same function of the larger suction stroke, preferably combined with a smaller stroke than the first suction cup.

In addition, an outlet nozzle for compressed air can be provided in front of the first suction cup in the feed direction on all suction cup units, which is aligned with the front edge of the flat component being sucked in to ensure that any adhering second flat component is ejected.

It is therefore advantageous for the transfer table to be movable in height in order to position the surface of the next flat component to be removed at approximately the same height for a stack of flat components when flat components are removed one after the other. A series of flat components can also be removed before a height adjustment is made if the suction cup units are suitably flexible.

In particular, one or more ultrasonic sensors can be provided in front of or between individual suction cups in order to detect the said distance of the side feed unit and, if necessary, to adjust the height of the side feed unit and/or the transfer table in order to reliably detect the topmost flat component of the stack when the side feed unit is lowered.

The designs shown in the drawings have four suction cup units, i.e. they can draw in and deposit four flat material parts one behind the other in the feed direction. Only two or three, or on the other hand five or six such suction cup units can also be provided. With two units, the time saving is limited to longer flat material part units; with six units, it must be a processing machine comprising a large number of sections.

Each of the suction cup units can be mounted on its own crossbeam, which can be moved independently of each other transversely to the feed direction on the frame component. This means that flat material parts of different widths can also be accommodated in a simple manner. The crossbars can each be driven and moved by a spindle drive or a magnetic linear guide.

A parking area for the side feed unit can be provided between the set-up area and the processing machine, so that the processing machine can perform the clamping movement of the beams required for the folding movement of a flat material part without this side feed unit spatially obstructing such a movement.

In an operating method for feeding flat material parts to a processing machine, the control unit controls the suction cup units in a pick-up step to pick up two or more flat material parts from the transfer table in a number corresponding to the maximum number of suction cup units, and the control unit then controls the individual two or more suction cup units in a multi-stage positioning step during a movement of the frame component in the feed direction into the processing machine in such a way that these successively deposit the picked-up flat material parts on the feed table in such a way that no overlapping of the deposited flat material parts occurs when viewed in the feed direction of the feed table. A predetermined distance can be defined.

By connecting the side feed unit transversely to the processing tool or tools laterally within the associated beam for a feeding movement of the flat material part in the direction of the processing edge of the flat material part, a feeding movement can be accomplished via a rail pivotally connected to the upper part, thereby enabling the lifting of the flat material part from a feeding table. The purpose of the side feed unit here is to ensure a feed movement of the flat material part in the direction of the processing edge of the flat material part. For this purpose, the side feed unit is movable transversely to the processing tool or tools, i.e. parallel to the processing edges of the processing tool or tools, and is connected to the associated beam within this beam. This enables the feeding movement of a flat material part in the direction of the processing edge of the flat material part, which makes it possible to load the device directly after a processed flat material part has been ejected to the front of the machine.

Advantageously, the loading or transfer table is arranged in a parallel plane and higher than the plane defined by the positioning table, so that the flat material part can be transferred without additional swivel movement of the side feed unit.

Further embodiments are given in the dependent claims.

### BRIEF DESCRIPTION OF THE DRAWINGS

The terms FIG., FIGS., Figure, and Figures are used interchangeably in the specification to refer to the corresponding figures in the drawings.

Preferred embodiments of the invention are described below with reference to the drawings, which are for explanatory purposes only and are not to be construed restrictively. The drawings show:

FIG. 1 shows a perspective view of a processing machine according to embodiments of the invention;

FIG. 2 shows a perspective view of the frame component of a side guide unit for a processing machine according to an embodiment of the invention;

FIG. 3 shows a perspective view of the frame component according to FIG. 2 from below;

FIG. 4 shows a perspective view of the frame component of a side guide unit for a processing machine according to a further embodiment of the invention;

FIG. 5 shows a perspective view of a set-up area of a processing machine according to a further embodiment of the invention;

FIG. 6 shows a perspective view of the frame component of a side guide unit for a processing machine according to a further embodiment of the invention; and

FIG. 7 shows a schematic sketch of the movement sequences when using the processing machine according to FIG. 1.

### DESCRIPTION OF THE INVENTION

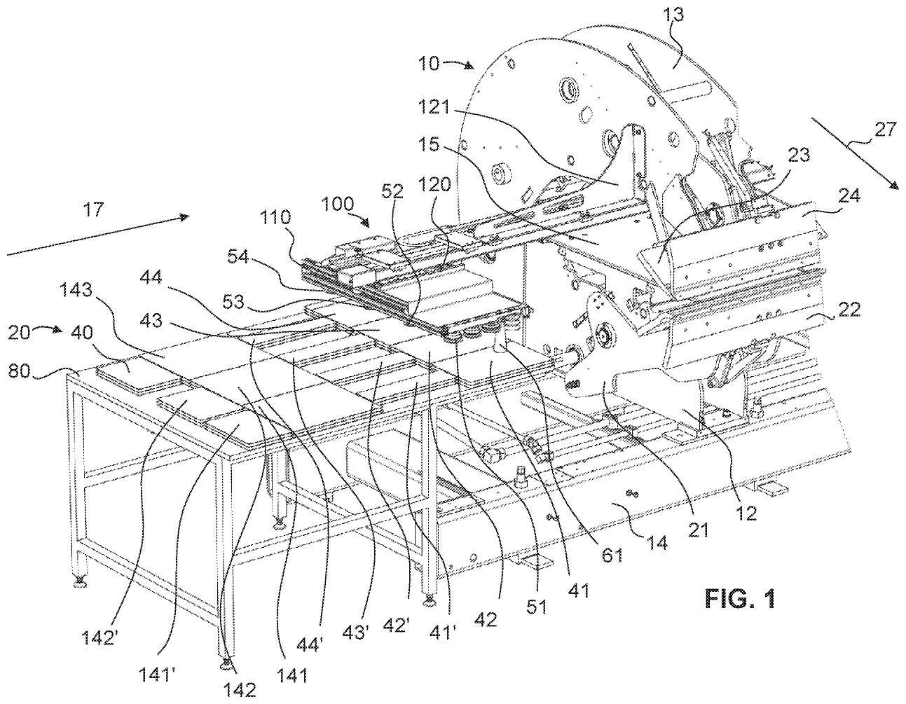

FIG. 1 shows a perspective view of a processing machine 10 according to embodiments of the invention. More precisely, FIG. 1 shows on the left side a set-up area 20 and on the right side the left part of the first section of the processing machine 10 with its upper part 13 and its lower part 12, which are arranged on a transversely extending frame 14. Processing machines 10 with four, six or eight sections, in which a transfer table 80 for a feed unit 100 is arranged on the left-hand end of the frame 14, are common. The frame 14 runs in the direction of the arrow 17, which is also the direction of the bending edges that can be produced with the processing machine 10. This direction runs transversely to the feed processing direction 27 of a flat material part 40 which, after positioning by the feed unit 100 in this feed processing direction 27, is pushed between the processing tools 22 and 24.

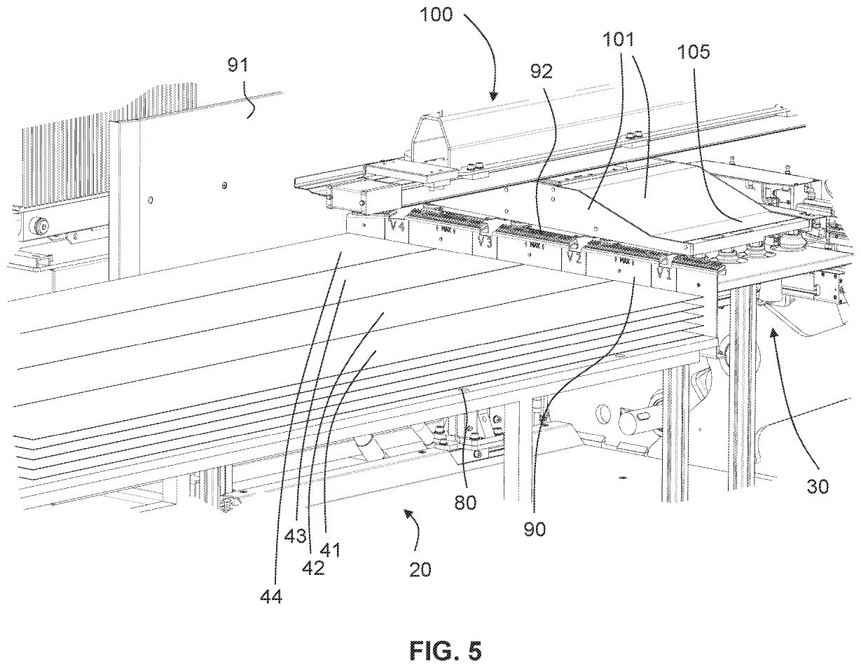

The section shown furthest to the left in FIG. 1 is the foremost section in front of the set-up area 20. A side feed unit 100 is provided here, which protrudes from this foremost section and is arranged above a transfer table 80 of the set-up area 20. Stops 90 and 91 (see FIG. 5) can be used for the flat material parts 40.

The upper part 13 is also referred to as the upper machine part and the lower part 12 as the lower machine part of such a sheet metal bending machine 10. This upper part 13 and/or this lower part 12 are arranged so as to be movable relative to one another perpendicular to the feed direction 17 of a workpiece or flat material part 40 to be bent. Vertical is to be understood here as a pivoting movement about a horizontal axis, essentially comprising a vertical component.

A lower holding beam 21 and a lower bending beam, also referred to as lower processing tool 22, are assigned to the lower machine part 12, and an upper holding beam 23 and an upper bending beam, also referred to as upper processing tool 24, are assigned to the upper machine part 13, wherein the four beams are aligned transversely to said feed direction 17 and the flat material part 40 to be bent can be inserted between said four beams between the machine parts, wherein the upper holding beam clamps the workpiece 40 to be bent in a clamping position relative to the lower holding beam. In said clamping position, the lower bending beam is set up to bend the flat material part 40 to be bent upwards about the front edge of the upper holding beam, wherein, in the case of a double bender, a further clamping position is set up so that the upper bending beam 24 can bend the flat material part 40 to be bent downwards about the front edge of the lower holding beam 21.

The upper parts 13 and lower parts 12 can be driven and articulated in a variety of ways, in particular also according to EP 3 403 738 A1 of the applicant. The processing machine 10 also does not have to be a double bending unit comprising a lower processing tool 22 and an upper processing tool 24, as shown here in FIG. 1. It can also be a single processing tool, in which case this is assigned to the feed and turning unit 50 as a side feed unit.

The side feed rail 120 is firmly connected to the upper part 13. This leads in particular to a saving of an axis to be moved, since lifting of the flat material part 40 by the suction cups 51 of the side feed unit 100 can thus be achieved simply by a slight opening (and thus skewing of the rail 120). In order to make it easy for the user to achieve the correct position of the flat material part 40 for insertion into the processing machine 10, a fixed transfer table 80 with stops 90, 91 is provided. The “stationary” refers to the stops of the transfer table 80 and not to the height of the support surface of the transfer table 80 for flat material parts 40. The transfer table 80 is movable in its height for this support surface in order to be able to process stacks of flat material parts 40 with this variable height, i.e. to move these into the processing machine without feeding new flat material parts 40 onto the transfer table 80 with the side feed unit 100.

The lateral stop 91 is not necessary, since the position of the flat material part 41, 42, 43, 44 in the direction of the arrow 17 is not critical, because the cutting length of the bending machine 10 always far exceeds the sum of the length of the flat material parts 41, 42, 43, 44, i.e. four times the length of a flat material part. In other embodiments, flat material parts of different lengths can also be provided, so that the individual flat material parts are deposited at correspondingly different distances from one another.

Several flat material parts are arranged on the transfer table 80; in the foremost line four flat material parts 41, 42, 43, 44 touching laterally, behind them four flat material parts 41′, 42′, 43′, 44′ which are narrower in the later feed processing direction 27, then behind them three wider and touching wider flat material parts 141, 142, 143 and finally two possibly irregularly wide flat material parts 141′, 142′ arranged next to each other, and then at a distance a flat material part 40. This last flat material part has specifically been given the reference sign, which is to be regarded as representative in the following when a “flat material part” as such is mentioned and can be replaced in each case by a different one. Essential to the invention, however, is the possibility of feeding two, three or four flat material parts to the processing machine 10 with one loading movement for each feeding step of the side feed unit 100.

The flat material parts 41 to 44 occupy the entire width of the transfer table 80, which is designed so that its width in relation to the accommodation of the flat material parts corresponds to the extension of the frame component 110 of the side feed unit 100.

The frame component 110 is arranged here below the side feed rail 120, which is arranged between the upper part 13 and the lower part 12 in the feed direction 17 and extends to the last section of the processing machine 10 in order to make it possible to position flat material parts 40 from the transfer table 80 of the set-up area 20 in the direction of the feed direction 17 up to the area of the furthest opposite and remote areas of the processing tools 22 or 23. In the present embodiment example, the side insertion rail 120 is attached to the upper part 13 of the first section by at least one L-profile 121.

The width of the frame component 110 again has a width so that it can be moved back and forth between the sections in the feed direction between the upper part 13 and the feed table 15, i.e. at the same time above the lower part 12.

The side feed unit 100 comprises a series of suction cups 51, 52, 53, 54 connected to a pneumatically operated vacuum source, whereby this connection is controlled, for example, via hydraulically activated valves. The suction cups 51 can also be referred to as suction cup units if, instead of one suction cup 51, three suction cups are arranged here in the feed direction 17. Behind these three suction cups 51, the virtual sensor cone 61 of an ultrasonic sensor provided in the frame component 110 in an aligned line is shown, which looks downwards onto the flat material part. This optional ultrasonic sensor emits ultrasound in the form of a cone onto the flat component 40 in order to detect the distance from the side feed unit 100 to this flat component 40 and to move the transfer table 80, which is advantageously adjustable in height, to the correct height position in order to pick up the flat component 40 lying opposite the suction cups 51, 52, 53 or 54. This makes particular sense if there is a stack of prepared flat components 40 lying on top of each other, as indicated in the figure.

Behind this ultrasonic sensor, a further suction cup 51′ is then arranged at a different height, in particular this further suction cup 51′ is arranged at a greater distance from the above-mentioned stack of flat components 40 and can optionally have a longer bellows in order to grip the surface of the uppermost flat component 40 of a stack simultaneously with the other three suction cups 51, but then, due to its higher arrangement in relation to the transfer table 80, lift the foremost (i.e. first to be drawn in) part of the flat component 40 in the feed direction 17 further away from the transfer table 80 and thus from the other flat component 40 of the stack lying below the now drawn-in flat component 40. Since this is done for the front region, adhesion of said further flat component 40 of the stack to the flat component 40 now to be inserted can be more successfully avoided. Of course, this further suction cup 51′ can and will advantageously be provided in the same way on the other suction cup rows with the reference signs 52, 53, 54, 151, 152, 153, 154.

The function of the suction cup units is switched on when one or the group of the four suction cups in this case is lowered onto the flat material part 40 and supported on it, so that the flat material part 40 adheres to the suction cups by a downstream suction of air located inside the individual suction cups. Normally, a vacuum is generated pneumatically and applied to the suction cups via hydraulically actuated valves, which vacuum is then constantly maintained. The suction cups can have bellows that simplify positioning and make it easier for the function of the other suction cup 51′ to become effective.

FIG. 1 then also shows the respective first suction cups 52, 53 and 54, which are each provided in the position of the flat material parts 42, 43 and 44 to be gripped, respectively, on the frame component 110, which are positioned above the flat material parts to be gripped below the frame component 110. This predetermines the distance between two rows of suction cups 51 and 52, or 52 and 53, or 53 and 54, which can be seen in the feed processing direction 27, and thus the positioning of the maximum of four flat materials 41, 42, 43, 44 or 41′, 42′, 43′ and 44′ which can be positioned “simultaneously” here.

If a user of the system has a processing machine 10 with, for example, six sections, he may also want to feed in six individual flat materials, which then requires a narrower distance between the suction cup units or a wider side feed unit 100. So that this side feed unit 100 can still be inserted between the beams 21 and 23, a lateral section 105 is advantageously designed with a lower height profile. This lateral section 105 is aligned in the direction of the processing edge of the processing machine 10 and utilizes the smaller free space between the two beams 21 and 23 in this area.

The side insertion rail 120 can be activated when, in the parking position of the upper beam or the lower beam, the subsequently activated suction cups 51, 52, 53, 54 of the four parallel suction cup units shown here are placed on the up to four flat material parts 41, 42, 43, 44 or 41′, 42′, 43, 44′, which are provided individually or, as shown here, as a stack of corresponding flat material parts on the transfer table 80 and the up to four flat material parts are gripped by pivoting upwards. The side feed rail 120 is then advanced into the processing machine 10 in the direction of the feed direction. It is possible, but not necessary, for the flat material parts to be rigid or to be held by the suction cups over the entire surface. It is also possible that the flat material parts are longer in the feed direction 17 than the associated suction cup unit and thus a free end of the flat material parts is trailed on the transfer table 80 and then pulled onto the feed table 15, which is arranged higher or lower than the transfer table 80. Then a flat material part is set down at each of four longitudinal positions of the side feed rail 120 moving the flat material parts in the feed direction 17, either by pivoting the frame component downwards or upwards, the flat material part thus set down is deposited on the positioning table moving out, so that processing by the bending tools then begins, in particular after the positioning table has moved back and the flat material part has been aligned.

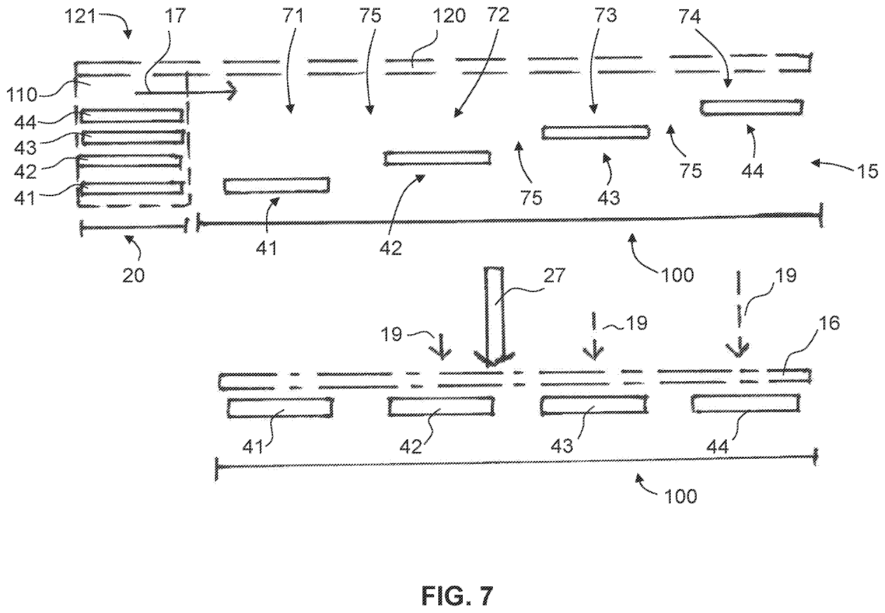

FIG. 7 shows a schematic sketch of the movement sequences when using the processing machine according to FIG. 1 according to an embodiment example. The movement of the four flat material parts 41, 42, 43, 44 from the set-up area 20 to various longitudinal positions 71, 72, 73, 74 on the infeed table 15 of the processing machine 100 is shown in the upper part of the drawing. The lines 20 and 100 schematically indicate the longitudinal alignment and position of the set-up area (left) and the processing machine (right). The side feed rail 120 of the side feed unit 100 is indicated by a dashed line and the frame component 110 docked to it is shown shortly after the start of the operating process, i.e. after leaving a possibly existing parking position and moving to a pick-up position 122 above the four flat material parts 41, 42, 43, 44 to be picked up. As explained above, the frame component 110 can be lowered or the entire side feed rail 120 on the upper part 13 is pivoted downwards in order to pick up the four flat material components 41, 42, 43, 44 after activation of the suction cup units in four rows of suction cups 51, 52, 53, 54.

The frame component 110 is then advanced in the direction of the feed direction 17. At the first longitudinal position 71, the first flat material part 41 is set down at the predetermined position by lowering the frame component 110 and/or the side insertion rail 120 by releasing the suction cup units. The suction cup units can also simply be released at the movement position and the flat material part 41 falls onto the feed table 15 at this point, unless it has already been partially trailed on the feed table 15. At the second longitudinal position 72, the second flat material part 42 is set down at the predetermined position by lowering the frame component 110 and/or the side feed rail 120 by releasing the suction cup units. The suction cup units can also simply be released at the movement position and the flat material part 42 falls onto the feed table 15 at this point, unless it has already been partially trailed on the feed table 15. For the third and fourth flat material parts 43 and 44, this process step is repeated at the third and fourth longitudinal positions 73 and 74, so that all four flat material parts 43 and 44 are then placed on the feed table 15. 44 come to rest on the feed table 15, but at different positions vis-à-vis the feed processing direction 27 of the processing machine 100. There is an intermediate distance 75 in the feed direction 17 between each flat material part 41 to 44 and its neighbor. This intermediate distance 75 can be reduced to almost zero. However, it is more advantageous to have an intermediate distance 75 so that the second process step can be carried out safely with appropriate clearance.

The feed table 15 usually has interruptions at various longitudinal positions in the feed direction, whereby these interruptions are then continuous in the feed processing direction 27. In particular, pushers 16 are provided in these interruptions, with which the flat material part to be processed is pushed through between the beams in the feed processing direction 27 in order to have it folded by the processing tools 22 and/or 42. As shown in FIG. 7, the fourth flat material 44 is then advanced furthest in accordance with the movement arrow 19. When the fourth piece of flat material 44 has reached the height of the third piece of flat material 43, it is carried along the remaining path by the pushers 16, so that this arrow 19 is shorter. The second flat material part 42 is pulled along even less and the first flat material part 41 remains in place. For better control of the movement, the first flat material part 41 is advantageously pushed further into a processing position together with the other flat material parts in this alignment step. In the sketch in FIG. 7, the slider is drawn as a continuous element. Usually, these are stops for the rear side of the respective flat material parts 40, 41, 42, 43, 44, which protrude from under the feed table 15 and move in slots.

It should also be pointed out that the sequence of depositing the flat material parts 41, 42, 43 and 44 does not have to take place in the manner shown. For example, the sequence of depositing the flat material parts can also be depositing in the sequence of flat material parts 44, 42, 41 and 43, in which the two “middle” flat material parts deposited in the longitudinal direction 17 are advanced a little by the pusher 16 if the two flat material parts to be processed at the edge of the processing machine 10 are the flat material parts to be advanced furthest. This also ensures that the difference in advancement between two neighboring flat material parts is a maximum of two distances between the suction cup units. This also works in reverse with the sequence of the flat material parts 41, 43, 44 and 42, where the flat material parts to be processed at the edges are then moved the least transversely and those placed in the middle are moved the most transversely.

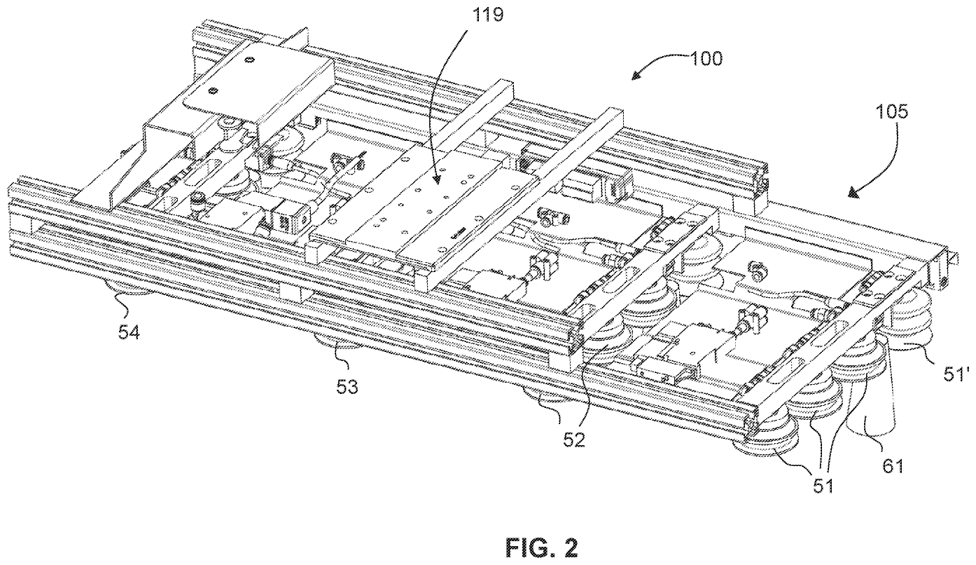

FIG. 2 shows a perspective view of the frame component 110 of a side feed unit 100 for a processing machine 10 according to an embodiment of the invention. Identical features are provided with identical reference signs in all figures, irrespective of their degree of schematization.

The frame component 110 has a fastening surface 119 on the upper side, to which the frame component 110 can be fastened on the movable carriage of a side feed rail 120. As already explained in connection with FIG. 1, there are four rows of four suction cups 51, 52, 53 and 54. Here, too, the foremost suction cup in the feed direction 17 is a further suction cup 51′ with a higher position of its bellows mouth when the flat material part 40 is completely sucked in for securely holding a single piece of a flat material part 40. The individual suction cup units of four suction cups 51 or 52 or 53 or 54 in each case can be controlled individually in order to distribute the flat material parts 41, 42, 43 and 44 taken along one after the other.

The side feed unit 100 then moves back after the flat material parts 41, 42, 43, 44 have been set down. In an alternative embodiment, the infeed table 15 can be extended when the flat material parts 41, 42, 43, 44 are set down. The flat material parts 41, 42, 43, 44 are then introduced into the machine 10 in an alignment step by retraction of the infeed table 15 in order to be advanced in a predetermined manner in the feed processing direction 27 after stopping at depth stops forming the slide 16 between sections of the infeed table 15 for processing. In other words, instead of an active slide 16, this can also be designed as a depth stop and the alignment step is carried out by the feed table 15 responsible for the feed movement required for the folding step, which can then be moved directly forwards again without interruption in order to enable the processing of the four sheets in this case simultaneously.

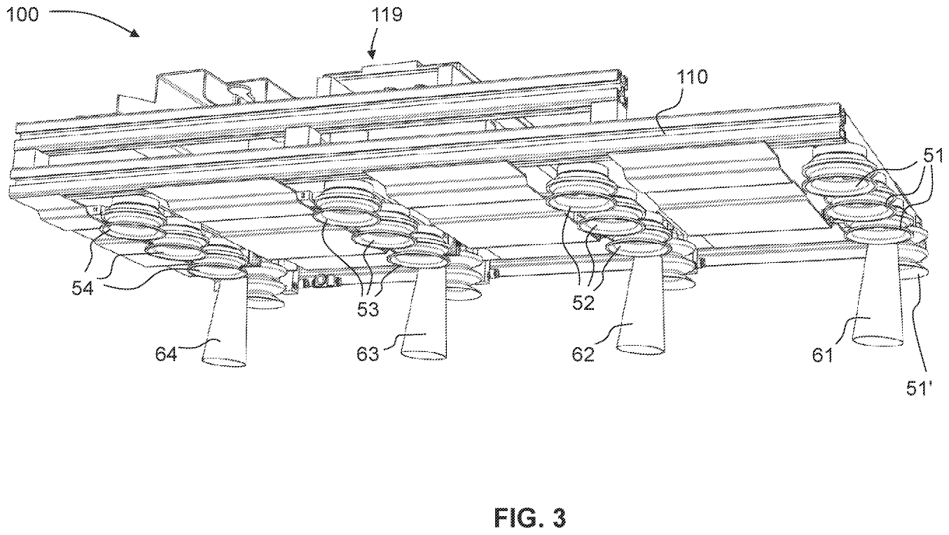

FIG. 3 shows a perspective view of the frame component 110 according to FIG. 2 laterally from below. In particular, the regular distribution of the four rows of suction cup units with suction cups 51, 52, 53, 54 and the four ultrasonic sensor sound cones 61, 62, 63 and 64 for the individual rows can be seen.

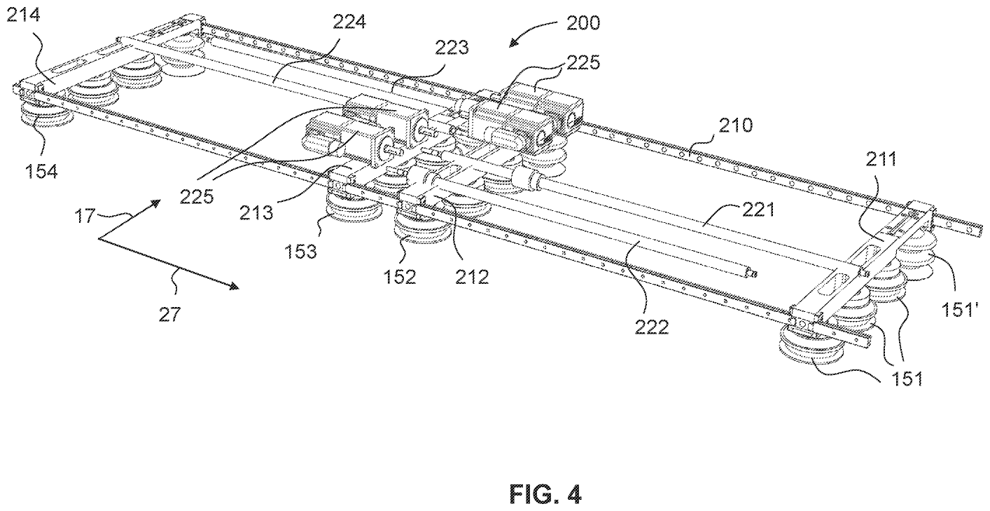

FIG. 4 shows a schematic perspective view of the frame component 210 of a side feed unit 200 for a processing machine according to a further embodiment of the invention. Here there is a frame component 210, of which only the two outer fixed supports are shown, which are connected to the side insertion rail not shown here. Four cross-members 211, 212, 213, 214 are mounted on this outer fixed support so as to be displaceable in the feed processing direction 27. Suction cup units are mounted below the cross members 211, 212, 213 and 214, as in the embodiment example of FIGS. 1 and 2, designated here as suction cups 151, 152, 153 or 154. The units 61, 62, 63, 64 shown in the first embodiment example are not shown here but may also be provided. Four spindle drives 225 are fixedly mounted on the frame component 210, each of which drives a spindle 221, 222, 223 or 224, each spindle being connected to an associated cross-member 211, 212, 213, 214 in order to displace it on the frame component 210 in the direction of the feed processing direction 27. In FIG. 4, the two outer crossbars 211 and 214 are moved to the edge of the frame component 210, while the inner crossbars 212 and 213 are moved close together in the middle. This makes it possible to pick up and position different configurations of flat material parts, in particular, for example, three flat material parts 141, 142 and 143 as shown in FIG. 1, if the crossbars are aligned accordingly. One of the three flat material parts can then be gripped by two suction cup units, for example.

When the flat material parts 41, 42, 43, 44 are picked up, the upper part 13 of the processing machine 10 is closed slightly, i.e. towards the lower beam 21, but not for clamping, but for docking the suction cups 51, 52, 53, 54 onto the flat material parts 41, 42, 43, 44. It is thus clear that the transfer table 80 is arranged parallel to the positioning and feed table 15. It can be arranged higher with respect to the horizontal, or it is arranged lower and has a corresponding magazine of preceding flat material parts 41, 42, 43, 44 and is then gradually raised manually or automatically in its height in order to safely receive the flat material parts 41, 42, 43, 44 offered to the machine 10. After the group of flat material parts 41, 42, 43, 44 has been sucked in, the upper part 13 is opened slightly, whereby the side feed rail 120 is raised and inclined about the same axis of rotation, so that the received flat material parts 41, 42, 43, 44 are lifted off the transfer table 80 and then moved by the frame component 110 along the side insertion rail 120 in the feed direction 17 until all the flat material parts 41, 42, 43, 44 have been gradually deposited in the processing machine 10.

After releasing the two or more flat material parts 40 positioned in the feed direction 17, these flat material parts can also be advanced precisely through the said depth stops, which are located between segments of the feed table 15 subdivided in the direction of the feed direction, without using the feed table 15, in order to then permit folding of all the flat material parts now positioned. To do this, the frame component 110 is moved out to the side. FIG. 5 shows the position of the frame component 110 laterally next to the foremost section of the processing machine 10, but in the direction of the feed direction 17 behind the transfer table 80, i.e. in a free space between this and the section of the processing machine 10, so that the frame component 110 can move freely as the upper part 3 is lowered to a clamping position without being hindered by the transfer table 80 or a next flat material part 40 already placed back on this. At the same time, this also addresses the time-advantageous simultaneous reloading of the machine 10 on the transfer table 80 while the processing steps of clamping and folding are still in progress.

FIG. 5 shows a perspective view of a set-up area 20 of a processing machine 10 according to a further embodiment of the invention. Here, a parking area 30 is provided between the set-up area 20 and the processing machine 10, in which the side feed unit 100 can be lowered for processing steps and the movement of the upper beam in a parking position. In addition, the side feed unit 100 is provided with side and top cover plates 101 so that the side section 105 with a lower height profile clearly stands out. The side feed unit 100 is set down on a table of the parking area 30.

The set-up area 20 has the transfer table 80, which is bounded here by two stops 90 and 91 that form an L. The rear stop 91 allows flat material parts 41, 42, 43, 44 (or in another embodiment 141, 142, 143) to be stacked next to each other. Here, five such flat material parts 41, 42, 43, 44 are shown schematically on top of each other and laterally adjacent to each other. The stop 90 in the direction of movement 27, on the other hand, has the function of arranging the flat material parts 41, 42, 43, 44 (or 41′, 42′, 43′, 44′ or 141, 142, 143) in such a way that they are received in the direction of the suction cup units in the same position with respect to the feed processing direction 27. The flat material parts are picked up by the frame component 110 (or 210) and lifted to such an extent that they can be moved over the stop 90 into the parking area 30 and then into the processing machine 10. In the process, they are moved via scraper brushes 92 arranged on the upper edge of the stop 90, which, in addition to the arrangement of the first and second row of suction cup units, ensure that two flat material parts lying on top of one another in the stack are not taken over into the processing machine 10 by adhesion, since the suction cup units cause a bending of the held flat material part by the scraper brushes 92 forming an edge and retain any lower flat material part which is present and has been pulled along with higher friction. In addition, the brushes protect the flat material parts from scratches and damage as an edge finish.

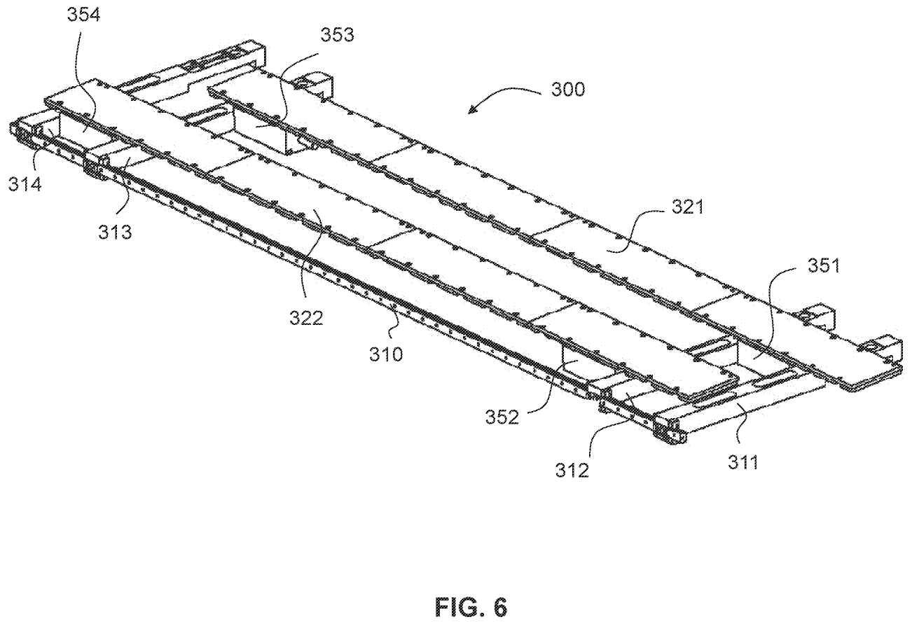

FIG. 6 shows a perspective view of the frame component 310 of a lateral guide unit 300 for a processing machine according to a further embodiment example of the invention, wherein it is a magnet-guided linear guide. Here, four traverses 311, 312, 313 and 314 are also provided on the frame component 310, which are also arranged in a sequence 311, 312, 313 and 314 from one end to the opposite end of the frame component, as in the embodiment example according to FIG. 4, and can be moved on the carriers of the frame component. They are each firmly connected to a magnet-guided bearing unit 351, 352, 353 and 354. The bearing units 351 and 353 are guided below the support rail 321 and the bearing units 352 and 354 are guided below the support rail 322. Thus, as in the embodiment according to FIG. 4, the suction cup units not shown here, which are to be arranged below the cross-members 311, 312, 313, 314, can be moved over almost the entire width of the frame component 310. The advantage here is that even all four crossbars can be positioned in one half of the frame component 310, i.e., for example, four narrower flat material parts 41′, 42′, 43′, 44′ can be stacked close together so that they can then be gripped in groups of four and positioned in the processing machine.

### LIST OF REFERENCE SYMBOLS

10 processing machine
12 lower part
13 upper part
14 frame
15 feed table
16 slider
17 feed direction of workpiece
19 movement arrow
20 set-up area
21 lower beam
22 lower processing tool
23 upper beam
24 upper processing tool
27 feed processing direction
30 parking area
40 flat material part (generic)
41 flat material part (wide)
42 flat material part (wide)
43 flat material part (wide)
44 flat material part (wide)
41′ flat material part (narrow)
42′ flat material part (narrow)
43 flat material part (narrow)
44′ flat material part (narrow)
51 suction cup
51 further suction cup (to prevent sticking)
52 suction cup
53 suction cup
54 suction cup
61 ultrasonic sensor
62 ultrasonic sensor
63 ultrasonic sensor
64 ultrasonic sensor
71 first longitudinal position
72 second longitudinal position
73 third longitudinal position
74 fourth longitudinal position
75 intermediate distance
80 transfer table
90 stop (direction of movement)
91 backside stop
92 scraper brush
100 side feed unit
101 cover plate
105 lateral section with lower height profile
110 frame component
119 fastening surface
120 side feed rail
121 L shaped profile
122 receiving position
141 flat material part (wider)
142 flat material part (wider)
143 flat material part (wider)
141′ flat material part (irregular)
142′ flat material part (irregular)
151 suction cup
151′ further suction cup
152 suction cup
153 suction cup
154 suction cup
200 side feed unit
210 frame component
211 first traverse
212 second traverse
213 third traverse
214 fourth traverse
221 spindle
222 spindle
223 spindle
224 spindle
225 spindle drive
300 side feed unit
310 frame component
311 first traverse
312 second traverse
313 third traverse
314 fourth traverse
321 carrier rail
322 carrier rail
351 storage unit
352 storage unit
353 storage unit
354 storage unit

1. A processing machine for flat material parts comprising:
a machine frame with a frame, a lower part and an upper part,
one lower beam,
one upper beam,
at least one processing tool associated with the lower beam or with the upper beam and held on the machine frame,
a control unit for controlling a processing sequence with the at least one processing tool,
a transfer table positioned to the side of the machine frame,
a feed table on which the flat material part to be processed can be placed for positioning in the processing machine, and
a side feed unit having:
a side feed rail which is fixedly connected to the machine frame,
a frame component connected with the side feed rail to be movable in a feed direction which corresponds to the processing edge of the flat material part,
two or more suction cup units mounted on the frame component offset transversely to the feed direction,
wherein the control unit is configured:
to control each of the two or more suction cup units separately one from one another,
to control the two or more suction cup units for picking up two or more flat material parts from the transfer table,
such that, when the frame component is moved in the feed direction into the processing machine, each one of the two or more suction cup units are actuated such that they successively deposit the picked-up flat material parts on the feed table for predetermined positioning such that, viewed in the feed processing direction of the feed table, no overlapping of the deposited flat material parts occurs.

2. The processing machine according to claim 1, in which each suction cup unit comprises a single suction cup or two or more suction cups arranged in a row one behind the other in the feed direction.

3. The processing machine according to claim 1, in which each suction cup unit comprises two or more suction cups arranged in a row one behind the other in the feed direction, wherein the foremost suction cup in the feed direction is positioned higher than the other suction cups, so that a foremost section of the flat material part in the feed direction is sucked in higher.

4. The processing machine according to claim 1, wherein three to five suction cups are arranged in a row one behind the other in the feed direction.

5. The processing machine according claim 1, wherein at least one ultrasonic sensor is provided in each suction cup unit for a distance measurement of the side feed unit from the surface of a one or uppermost flat material part resting on the transfer table.

6. The processing machine according to claim 1, in which the upper side of the transfer table can be moved adjustably in its height.

7. The processing machine according to claim 1, in which two to six suction cup units are provided parallel to one another for parallel reception of a corresponding number of flat material parts.

8. The processing machine according to claim 1, wherein the frame component comprises a number of crossbeams, which are each movable independently of one another transversely to the feed direction on the frame component, wherein the number of crossbeams is equal to the number of suction cup units, wherein each of the suction cup units is mounted on one of the crossbeams.

9. The processing machine according to claim 8, in which the crossbeams are each driven and movable by a spindle drive or a magnetic linear guide.

10. The processing machine according to claim 1, further comprising a parking area being provided between the set-up area and the processing machine.

11. The processing machine according to claim 1, wherein the transfer table has a stop in the feed direction for flat material parts moving in the feed direction.

12. The processing machine according to claim 11, in which a wiper brush is provided on the upper edge of the stop.

13. The processing machine according to claim 1, wherein the transfer table has a rear stop for flat material parts in the opposite direction to the feed processing direction.

14. The processing machine according to claim 1, wherein the number of flat material parts to be picked up corresponds at most to the number of suction cup units.

15. A method for feeding flat material parts to a processing machine, wherein the processing machine comprises:
a machine frame with a frame, a lower part and an upper part,
one lower beam,
one upper beam,
at least one processing tool associated with the lower beam or with the upper beam and held on the machine frame,
a control unit for controlling a processing sequence with the at least one processing tool,
a transfer table positioned to the side of the machine frame,
a feed table on which the flat material part to be processed can be placed for positioning in the processing machine, and
a side feed unit having:
a side feed rail which is fixedly connected to the machine frame,
a frame component connected with the side feed rail to be movable in a feed direction which corresponds to the processing edge of the flat material part,
two or more suction cup units mounted on the frame component offset transversely to the feed direction,
wherein the control unit is configured:
to control each of the two or more suction cup units separately one from one another,
to control the two or more suction cup units for picking up two or more flat material parts from the transfer table,
wherein the method comprises, controlled by the control unit the steps of:
picking-up step wherein two or more flat material parts are picked up from the transfer table,
a flat material moving step wherein the two or more flat material parts are moved in the feed direction of the flat material parts in the feed direction,
a number of subsequent positioning steps which number is equal to the number of picked up flat material parts, wherein, during a movement of the frame component in the feed direction into the processing machine, each one of the two or more suction cup units successively deposit the picked-up flat material parts on the feed table in such a way that no overlapping of the deposited flat material parts occurs when viewed in the feed processing direction of the feed table.
